(19) United States
(12) Patent Application Publication
(10) Pub. No.: US 2022/0053163 A1
(43) Pub. Date: Feb. 17, 2022

(54) WIDEBAND SPLITTER

(71) Applicant: PPC BROADBAND, INC., East Syracuse, NY (US)

(72) Inventors: Erdogan Alkan, Manlius, NY (US); David A. Barany, Syracuse, NY (US)

(21) Appl. No.: 17/384,995

(22) Filed: Jul. 26, 2021

Related U.S. Application Data
(60) Provisional application No. 63/065,603, filed on Aug. 14, 2020.

(51) Int. Cl. H04N 7/10; H01P 5/12

(52) U.S. Cl. CPC H04N 7/104; H01P 5/12

(57) ABSTRACT

A wideband splitter includes an input port configured to receive an input signal; two or more output ports configured to output the input signal. The wideband splitter is capable of splitting the input signal and transmitting the split input signal to the output ports across a frequency band ranging from approximately 5 MHz to 3000 MHz.

### CROSS-REFERENCE TO RELATED APPLICATION

This application claims priority to U.S. Provisional Patent Application No. 63/065,603, filed Aug. 14, 2020, the disclosure of which is incorporated herein by reference in its entirety.

### TECHNICAL FIELD

The present disclosure relates generally to CATV distribution systems and more specifically, to a signal splitter device for the distribution and combining of CATV signals.

### BACKGROUND

Cable Television (CATV) systems may carry content (e.g., television content) across a range of frequency bands and channels. As more CATV services become available, the greater the demand for a higher range of frequency bands.

CATV systems (e.g., in residential and/or non-residential environments) may include splitters that include an input to receive an input signal, and multiple outputs. The outputs may connect to CATV network compatible devices (e.g., televisions, television equipment, set-top-boxes, broadband network devices, etc.) such that these devices can connect to the CATV network from a single input connection to a customer premises. Effective splitters pass signals at the frequency bands at which the CATV network operates. Thus, as the range of frequency bands at which a CATV operates increases or becomes wider, an effective splitter should pass signals at the wider frequency bands. Splitters may be constructed from magnetic materials (e.g., ferrites) which may perform relatively well in splitting signals at relatively lower frequencies (e.g., below 1000 to 1600 megahertz (MHz)). A Wilkson splitter splits an input signal into two equal phase output signals, or combines two equal-phase signal into one in the opposite direction.

### SUMMARY

In one example aspect, a wideband splitter includes: an input port; a first splitter; a second splitter; a first diplexer; a second diplexer; a third diplexer; a first output port; and a second output port. The input port is coupled to the first diplexer and transmits an input signal received at the input port to the first diplexer; a low-pass node of the first diplexer is coupled to the first splitter and transmits the input signal at a first frequency band to the first splitter; a high-pass node of the first diplexer is coupled to the second splitter and transmits the input signal at a second frequency band to the second splitter; the first splitter is coupled to a low-pass node of the second diplexer and to a low-pass node of the third diplexer and transmits signals of the first frequency band to the second diplexer and to the third diplexer; the second splitter is coupled to a high-pass node of the second diplexer and to a high-pass node of the third diplexer and transmits signals of the second frequency band to the second diplexer and to the third diplexer; the second diplexer is coupled to the first output port and combines the signals of the first and second frequency bands received from the first splitter and the second splitter; and the third diplexer is coupled to the second output port and combines the signals of the first and second frequency bands received from the first splitter and the second splitter.

In an example aspect, a wideband splitter includes: an input port; a first splitter; a second splitter; a first diplexer; a second diplexer; a third diplexer; a first output port; and a second output port. The input port is coupled to the first diplexer and transmits an input signal to the first diplexer; a low-pass node transmits the input signal at a first frequency band to the first splitter; a high-pass node of the first diplexer transmits the input signal at a second frequency band to the second splitter; the first splitter transmits signals of the first frequency band to the second diplexer and to the third diplexer; the second splitter transmits signals of the second frequency band to the second diplexer and to the third diplexer; the second diplexer combines the signals of the first and second frequency bands received from the first splitter and the second splitter; and the third diplexer combines the signals of the first and second frequency bands received from the first splitter and the second splitter.

In an example aspect, a wideband splitter includes an input port configured to receive an input signal; two or more output ports configured to output the input signal. The wideband splitter is capable of splitting the input signal and transmitting the split input signal to the output ports across a frequency band ranging from approximately 5 MHz to 3000 MHz or higher.

### BRIEF DESCRIPTION OF THE DRAWINGS

FIG. 1A illustrates an overview of an example wideband splitter in accordance with aspects of the present disclosure.

FIG. 1B illustrates an example of a wideband 4-way splitter in accordance with aspects of the present disclosure.

FIG. 1C illustrates an example of a wideband 4-way splitter in accordance with aspects of the present disclosure.

FIG. 2 illustrates a graph of example performance measurements of the wideband splitter illustrated in FIG. 1A.

FIG. 3 illustrates a layout of an example Wilkinson power divider that may be used in accordance with of aspects of the present disclosure.

### DETAILED DESCRIPTION

Effective splitters pass signals at the frequency bands at which the CATV network operates. More specifically, an “effective” splitter is a splitter that minimizes through loss of signals traveling from the input port to the output ports, and maximizes return loss of at each port. Thus, as the range of frequency bands at which a CATV operates increases or becomes wider, an effective splitter should minimize through loss of signals at the wider frequency bands traveling from the input port to the output ports, while also maximizing return loss.

Splitters may be constructed from magnetic materials (e.g., ferrites) which may perform relatively well in splitting signals at relatively lower frequencies (e.g., below 1000 MHz). However, at relatively higher frequency ranges (e.g., above 1000 MHz), the performance of ferrite-based splitters may degrade significantly. Addressing this degradation using ferrites may be extremely costly and difficult to manufacture. A Wilkinson splitter may perform relatively well in splitting signals at relatively higher frequencies (e.g., above 1000 MHz), but may perform relatively poorly at lower frequencies. Accordingly, aspects of the present disclosure may include a wideband splitter that leverages both a ferrite splitter and a Wilkinson splitter to split an input signal across a relatively wide frequency band (e.g., approximately 5 MHz to 3000 MHz or greater).

As described herein, the wideband splitter, in accordance with aspects of the present disclosure, combines the strengths of ferrite and Wilkinson splitters by a coupling technique. With such an approach, these two splitters are split at the input and their outputs are recombined via diplexing or other coupling techniques. More specifically, aspects of the present disclosure may include a ferrite splitter to split signals at a first frequency band (e.g., a relatively low frequency band), and Wilkinson splitter to split signals at second frequency band (e.g., a relatively high frequency band). These split signals may then be recombined to form output signals that pass both low and high frequency band signals at relatively low through loss.

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

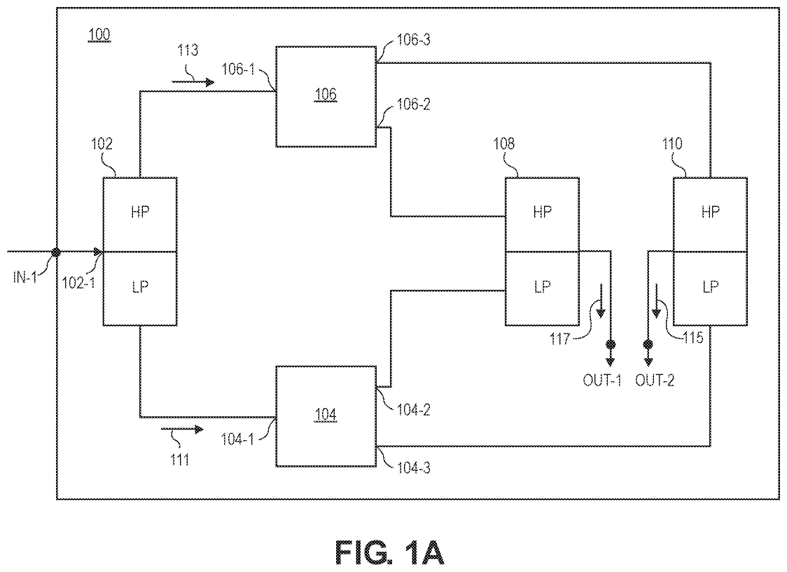

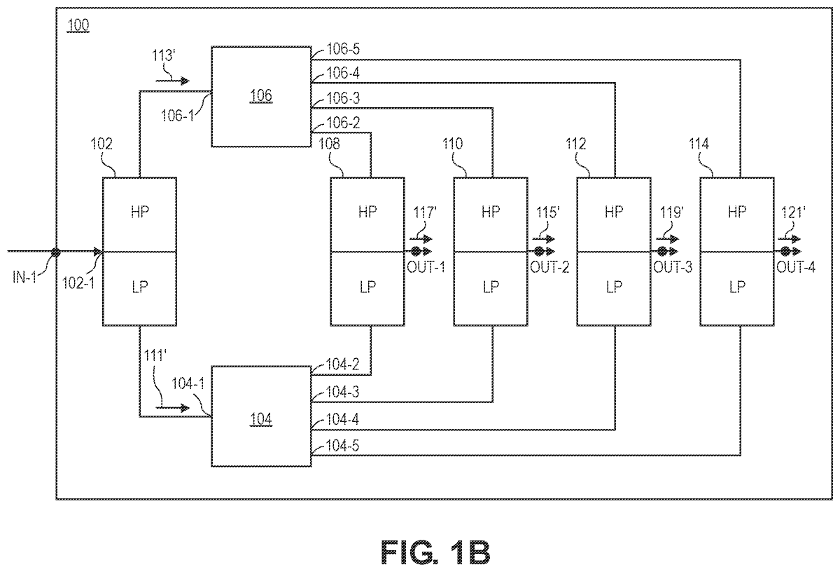

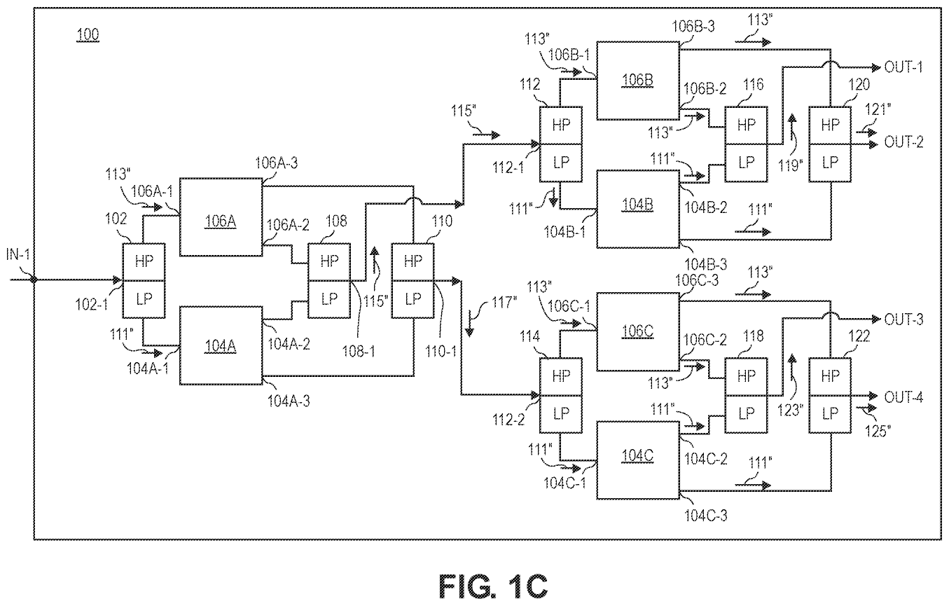

FIG. 1A illustrates an overview of an example wideband splitter in accordance with aspects of the present disclosure. As shown in FIG. 1A, a wideband splitter 100 may include an input port (IN-1) and two output ports (OUT-1 and OUT-2). As described herein, the wideband splitter 100 may be located at a customer premise and split a single input connection into two connections (e.g., to connect two CATV network compatible devices to the single input connection). In some embodiments, the input port and the output ports may be coaxial cable connections or other types of connections. In some embodiments, the input port may receive a signal (e.g., an RF cable signal) from a CATV network. For example, the input port may be connected directly to the CATV network, or via additional splitters and components.

As further shown in FIG. 1A, the wideband splitter 100 may include a first coupling unit (e.g., first diplexer 102), a first splitter (e.g., a ferrite splitter 104), a second splitter (e.g., a Wilkinson splitter 106), a second coupling unit (e.g., second diplexer 108), and a third coupling unit (e.g., third diplexer 110). As further shown in FIG. 1A, the input port may be coupled to a common node 102-1 of the diplexer 102. A low-pass (LP) node of the diplexer 102 may be coupled to a common node 104-1 of the ferrite splitter 104, and a high-pass (HP) node of the diplexer 102 may be coupled to a common node 106-1 of the Wilkinson splitter 106. A first output 104-2 of the ferrite splitter 104 may be coupled to a LP node of the diplexer 108, and a second output 104-3 of the ferrite splitter 104 may be coupled to a LP node of the diplexer 110. A first output 106-2 of the Wilkinson splitter 106 may be coupled to a HP node of the diplexer 108, and a second output 106-3 of the Wilkinson splitter 106 may be coupled to a HP node of the diplexer 110.

In some embodiments, the common node 102-1 may receive an input signal via the input port IN-1. As described herein, the input signal may be a wideband signal having frequencies ranging from 5 MHz to 3000 MHz, or greater. The diplexer 102 may split the input signal into low-pass and high-pass signals. As previously discussed, the ferrite splitter 104 may perform relatively well (e.g., meet or exceed through loss and return loss performance thresholds) when splitting low-frequency signals (e.g., signals 111 within a first frequency band 111). The Wilkinson splitter 106 may perform relatively well (e.g., meet or exceed through loss and return loss performance thresholds) when splitting high-frequency signals (e.g., signals within a second frequency band). Accordingly, the low-pass signals 111 (e.g., in the first frequency band) may be transmitted to the ferrite splitter 104 via the common node 104-1. The high-pass signals 113 (e.g., in the second frequency band) may be transmitted to the Wilkinson splitter 106 via the common node Wilkinson splitter 106-1.

The ferrite splitter 104 may split the signals 111 in the first frequency band and output the signals via the output ports 104-2 and 104-3 to the LP node of the diplexer 108 and the LP node of the diplexer 110, respectively. The Wilkinson splitter 106 may split the signals 113 in the second frequency band and output the signals via the output ports 106-2 and 106-3 to the HP node of the diplexer 108 and the HP node of the diplexer 110, respectively. The diplexer 108 may combine the low-pass signals 111 from the output port 104-2 and the high-pass signals 113 from the output port 106-2 to form a signal 117 having both the first and second frequency bands, transmitted via the output port OUT-1. The diplexer 110 may combine the low-pass signals 111 from the output port 104-3 and the high-pass signals 113 from the output port 106-3 to form a signal 115 having both the first and second frequency bands, transmitted via the output port OUT-2. In this way, the two output ports OUT-1 and OUT-2 carry signals 115, 117 with both the first and second frequency band. In some embodiments, the first frequency band may include frequencies from 5 MHz to 1000 MHz, and the second frequency band may include frequencies from 1000 MHz to 3000 MHz, or greater. Thus, the wideband splitter 100, described herein, splits the input wideband signal having frequencies ranging from 5 MHz to 3000 MHz, or greater to two output signals 115, 117.

FIG. 1B illustrates an example of a wideband 4-way splitter in accordance with aspects of the present disclosure. As shown in FIG. 1B, the wideband splitter 100 may include a first coupling unit (e.g., first diplexer 102), a first splitter (e.g., a ferrite splitter 104), a second splitter (e.g., a Wilkinson splitter 106), a second coupling unit (e.g., second diplexer 108), a third coupling unit (e.g., third diplexer 110), a fourth coupling unit (e.g., fourth diplexer 112), and a fifth coupling unit (e.g., fifth diplexer 114). As further shown in FIG. 1B, an input port IN-1 may be coupled to a common node 102-1 of the diplexer 102. A LP node of the diplexer 102 may be coupled to a common node 104-1 of the ferrite splitter 104, and a HP node of the diplexer 102 may be coupled to a common node 106-1 of the Wilkinson splitter 106. A first output 104-2 of the ferrite splitter 104 may be coupled to a LP node of the diplexer 108, a second output 104-3 of the ferrite splitter 104 may be coupled to a LP node of the diplexer 110, a third output 104-4 of the ferrite splitter 104 may be coupled to a LP node of the diplexer 112, and a fourth output 104-5 of the ferrite splitter 104 may be coupled to a LP node of the diplexer 114. A first output 106-2 of the Wilkinson splitter 106 may be coupled to a HP node of the diplexer 108, a second output 106-3 of the Wilkinson splitter 106 may be coupled to a HP node of the diplexer 110, a third output 106-4 of the Wilkinson splitter 106 may be coupled to a HP node of the diplexer 112, and a fourth output 106-5 of the Wilkinson splitter 106 may be coupled to a HP node of the diplexer 114. Each of the diplexer 108, diplexer 110, diplexer 112, and diplexer 114 may include an output port (e.g., OUT-1, OUT-2, OUT-3, and OUT-4, respectively).

In some embodiments, the common node 102-1 may receive an input signal via the input port IN-1. As described herein, the input signal may be a wideband signal having frequencies ranging from 5 MHz to 3000 MHz, or greater. The diplexer 102 may split the input signal into low-pass and high-pass signals 111′, 113′ thorough LP and HP nodes of the diplexer 102. In some embodiments, the low-pass signals 111′ (e.g., in the first frequency band) may be transmitted to the ferrite splitter 104 via the common node 104-1. The high-pass signals 113 (e.g., in the second frequency band) may be transmitted to the Wilkinson splitter 106 via the common node Wilkinson splitter 106-1.

The ferrite splitter 104 may split the signals 111′ in the first frequency band and output the signals via the output ports 104-2, 104-3, 104-4, and 104-5 to the LP node of the diplexer 108, the LP node of the diplexer 110, the LP node of the diplexer 112, and the LP node of the diplexer 114, respectively. The Wilkinson splitter 106 may split the signals 113′ in the second frequency band and output the signals 113′ via the output ports 106-2, 106-3, 106-4, and 106-5 to the HP node of the diplexer 108, the HP node of the diplexer 110, the HP node of the diplexer 112, and the HP node of the diplexer 114 respectively. The diplexer 108 may combine the low-pass signals from the output port 104-2 and the high-pass signals from the output port 106-2 to form a signal 117′ having both the first and second frequency bands, transmitted via the output port OUT-1. The diplexer 110 may combine the low-pass signals 111′ from the output port 104-3 and the high-pass signals 113′ from the output port 106-3 to form a signal 115′ having both the first and second frequency bands, transmitted via the output port OUT-2. The diplexer 112 may combine the low-pass signals 111′ from the output port 104-4 and the high-pass signals 113′ from the output port 106-4 to form a signal 119′ having both the first and second frequency bands, transmitted via the output port OUT-3. The diplexer 114 may combine the low-pass signals 111′ from the output port 104-5 and the high-pass signals 113′ from the output port 106-5 to form a signal 121′ having both the first and second frequency bands, transmitted via the output port OUT-4. In this way, the four output ports OUT-1, OUT-2, OUT-3, and OUT-4 carry signals 115′, 117′, 119′, 121′ with both the first and second frequency band. In some embodiments, the first frequency band may include frequencies from 5 MHz to 1000 MHz, and the second frequency band may include frequencies from 1000 MHz to 3000 MHz, or greater. Thus, the wideband splitter 100, described herein, splits the input wideband signal having frequencies ranging from 5 MHz to 3000 MHz, or greater to four output signals 115′, 117′, 119′, 121′.

FIG. 1C illustrates an example of a wideband 4-way splitter in accordance with aspects of the present disclosure. As shown in FIG. 1C, the wideband splitter 100 may include a first coupling unit (e.g., first diplexer 102), a first ferrite splitter 104A, a first Wilkinson splitter 106A, a second ferrite splitter 104B, a third ferrite splitter 104C, a first Wilkinson splitter 106A, a second Wilkinson splitter 106B, a third Wilkinson splitter 106C, a second coupling unit (e.g., second diplexer 108), a third coupling unit (e.g., third diplexer 110), a fourth coupling unit (e.g., fourth diplexer 112), a fifth coupling unit (e.g., fifth diplexer 114), a sixth coupling unit (e.g., fifth diplexer 116), a seventh coupling unit (e.g., seventh diplexer 118), an eight coupling unit (e.g., eight diplexer 120), and a ninth coupling unit (e.g., ninth diplexer 122). As further shown in FIG. 1C, an input node (IN-1) of the diplexer 102 may be to a common node 102-1 of the diplexer 102. A LP node of the diplexer 102 may be coupled to a common node 104A-1 of the ferrite splitter 104, and a HP node of the diplexer 102 may be coupled to a common node 106A-1 of the Wilkinson splitter 106. A first output 104A-2 of the ferrite splitter 104A may be coupled to a LP node of the diplexer 108, and a second output 104A-3 may be coupled to a LP node of the diplexer 110. A first output 106A-2 of the Wilkinson splitter 106A may be coupled to a HP node of the diplexer 108, and a second output 106A-3 may be coupled to a HP node of the diplexer 110. A common node 108-1 of the diplexer 108 may be coupled to a common node 112-1 of the diplexer 112, and a common node 110-1 of the diplexer 110 may be coupled to a common node 114-1 of the diplexer 114.

A LP node of the diplexer 112 may be coupled to a common node 104B-1 of the ferrite splitter 104B, and a HP node of the diplexer 112 may be coupled to a common node 106B-1 of the Wilkinson splitter 106B. A first output 104B-2 of ferrite splitter 104B may be coupled to a LP node of the diplexer 116, and a second output 104B-3 of the ferrite splitter 104B may be coupled to a LP node of the diplexer 120. A first output 106B-2 of Wilkinson splitter 106B may be coupled to a HP node of the diplexer 116, and a second output 106B-3 of the Wilkinson splitter 106B may be coupled to a HP node of the diplexer 120. The diplexer 116 may be coupled to a first output (OUT-1) and the diplexer 120 may be coupled to a second output (OUT-2).

A LP node of the 114 may be coupled to a common node 104C-1 of the ferrite splitter 104C, and a HP node of the diplexer 114 may be coupled to a common node 106C-1 of the Wilkinson splitter 106C. A first output 104C-2 of ferrite splitter 104C may be coupled to a LP node of the diplexer 118, and a second output 104C-3 of the ferrite splitter 104C may be coupled to a LP node of the diplexer 122. A first output 106C-2 of Wilkinson splitter 106C may be coupled to a HP node of the diplexer 118, and a second output 106C-3 of the Wilkinson splitter 106C may be coupled to a HP node of the diplexer 122. The diplexer 118 may be coupled to a third output (OUT-3) and the diplexer 122 may be coupled to a fourth output (OUT-4).

The common node 102-1 may receive an input signal via the input port IN-1. As described herein, the input signal may be a wideband signal having frequencies ranging from 5 MHz to 3000 MHz, or greater. The diplexer 102 may split the input signal into low-pass and high-pass signals 111″, 113″ thorough LP and HP nodes of the diplexer 102. In some embodiments, the low-pass signals 111″ (e.g., in the first frequency band) may be transmitted to the ferrite splitter 104A via the common node 104A-1. The high-pass signals 113″ (e.g., in the second frequency band) may be transmitted to the Wilkinson splitter 106A via the common node Wilkinson splitter 106A-1.

The ferrite splitter 104A may split the signals 111″ in the first frequency band and output the signals 111″via the output ports 104A-2 and 104A-3 to the LP node of the diplexer 108 and the LP node of the diplexer 110, respectively. The Wilkinson splitter 106A may split the signals in the second frequency band 113″ and output the signals 113″ via the output ports 106A-2 and 106A-3 to the HP node of the diplexer 108 and the HP node of the diplexer 110, respectively. The diplexer 108 may combine the low-pass signals 111″ from the output port 104A-2 and the high-pass signals 113″ from the output port 106A-2 to form a signal 115″ having both the first and second frequency bands, and transmit the signal 115″ to the common node 112-1 of the diplexer 112. The diplexer 110 may combine the low-pass signals 111″ from the output port 104A-3 and the high-pass signals 113″ from the output port 106A-3 to form a signal 117″ having both the first and second frequency bands, and transmit the signal 117″ to the common node 114-1 of the diplexer 114.

The diplexer 112 may split the signal 115″ from the common port 112-1 to the first and second frequency bands (e.g., low and high frequency bands) and transmit the low-frequency signals 111″ to the ferrite splitter 104B and transmit the high-frequency signals 113″ to the Wilkinson splitter 106B. The ferrite splitter 104B may split the low-frequency signals 111″ to the diplexer 116 and diplexer 120 via the output ports 104B-2 and 104B-3, respectively. The Wilkinson splitter 106B may split the high-frequency signals 113″ to the diplexer 116 and diplexer 120 via the output ports 106B-2 and 106B-3, respectively. The diplexer 116 may combine the low-frequency signals 111″ and the high-frequency signals 113″, received from the ferrite splitter 104B and the Wilkinson splitter 106B and output the combined signal 119″ via OUT-1. The diplexer 120 may combine the low-frequency signals and the high-frequency signals, received from the ferrite splitter 104B and the Wilkinson splitter 106B and output the combined signal 121″ via OUT-2.

The diplexer 114 may split the signal 117″ from the common port 114-1 to the first and second frequency bands (e.g., low and high frequency bands) and transmit the low-frequency signals 111″ to the ferrite splitter 104C and transmit the high-frequency signals 113″ to the Wilkinson splitter 106C. The ferrite splitter 104C may split the low-frequency signals 111″ to the diplexer 118 and diplexer 112 via the output ports 104C-2 and 104C-3, respectively. The Wilkinson splitter 106C may split the high-frequency signals 113″ to the diplexer 118 and diplexer 122 via the output ports 106C-2 and 104C-3, respectively. The diplexer 118 may combine the low-frequency signals 111″ and the high-frequency signals 113″, received from the ferrite splitter 104C and the Wilkinson splitter 106C and output the combined signal 123″ via OUT-3. The diplexer 122 may combine the low-frequency signals 111″ and the high-frequency signals 113″, received from the ferrite splitter 104C and the Wilkinson splitter 106C and output the combined signal 125″ via OUT-4. In this way, the wideband splitter 100 of FIG. 1C splits a single wideband input signal (e.g., ranging from frequencies of approximately 5 MHz to 3000 MHz or greater) into four wideband output signals 119″, 121″, 123″, 125″.

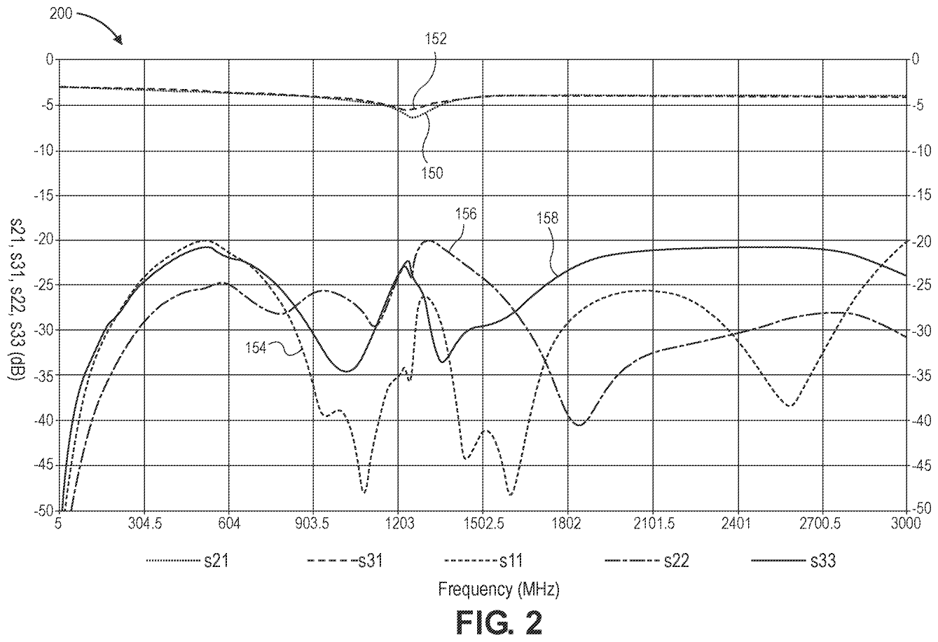

FIG. 2 illustrates a graph of example performance measurements of the wideband splitter illustrated in FIG. 1A. More specifically, the graph 200 illustrates through loss between ports 1, 2, and 3, and return loss of ports 1, 2, and 3 of the wideband splitter 100 of FIG. 1 at operating frequencies ranging from 5 MHz to 3000 MHz. As described herein, port 1 refers to the input port IN-1 of the wideband splitter 100, port 2 refers to the output port OUT-1 of the wideband splitter 100, and port 3 refers to the output port OUT-2 of the wideband splitter 100. In the graph 200, the notation “s21” (or element 150) refers to the through loss from port 2 to port 1 of the wideband splitter 100 of FIG. 1 (i.e., the through loss from OUT-1 to IN-1). The notation “s31” (or element 152) refers to the through loss from port 3 to port 1 of the wideband splitter 100 of FIG. 1 (i.e., the through loss from OUT-2 to IN-1). The notation “s11” (or element 154) refers to the return loss at port 1 (i.e., the return loss at IN-1). The notation “s22” (or element 156) refers to the return loss at port 2 (i.e., the return loss at OUT-1). The notation “s33” (or element 158) refers to the return loss at port 3 (i.e., the return loss at OUT-1).

As shown in the graph 200, the through loss between port 2 and port 1 and port 3 and port 1 is relatively low, at approximately 3 decibels (dB) from 5 MHz to 3000 MHz. That is, the wideband splitter 100 splits the input signal into two output ports with relatively low through loss, or a relatively low level of signal strength degradation. As further shown in the graph 200, the return loss at the ports 1, 2, and 3, is relatively high (e.g., greater than approximately 20 dB across 5 MHz to 3000 MHz). As such, the wideband splitter 100 performs at a high level across a wide frequency band ranging from, for example, 5 MHz to 3000 MHz.

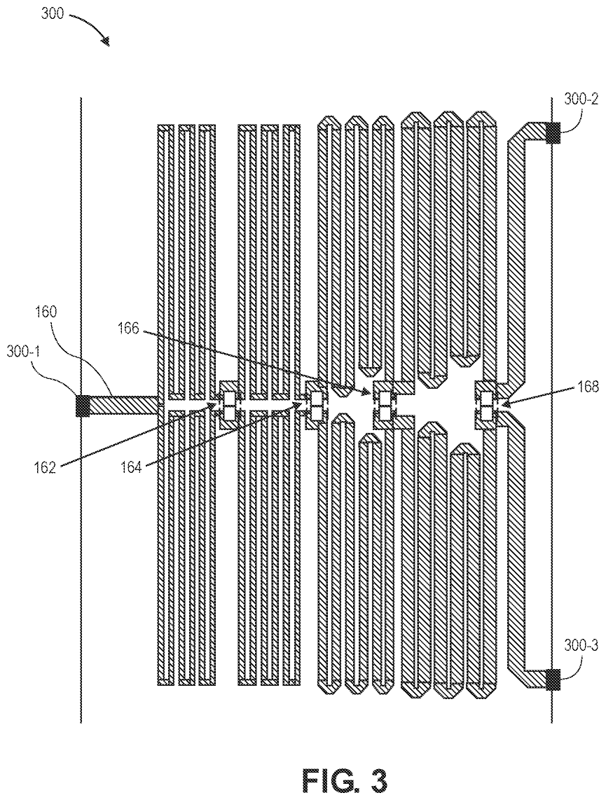

FIG. 3 illustrates a layout of an example power divider that may be used in accordance with of aspects of the present disclosure. More specifically, FIG. 3 illustrates a layout of a 4-stage Wilkinson power divider 300 that may be used to split an input signal across a frequency band (e.g., ranging from 300 MHz to 1800 MHz). As shown in FIG. 3, the power divider 300 may include a transmission line 160 coupled in a 4-stage configuration (e.g., with 4 resistors, 162, 164, 166, 168), with two output ports 300-2 and 300-3. In some embodiments, the transmission line transmits an input signal received at port 300-1 to output ports 300-2 and 300-3 across the transmission line and resistors. The resistors (first resistor 162, second resistor 164, third resistor 166, fourth resistor 168) are provided to match ports 300-1, 300-2, and 300-3, and to isolate port 300-2 from port 300-3. As described herein, the power divider of FIG. 3 may provide relatively low through loss and relatively high return loss for signals split between 300 MHz to 1800 MHz, and thus, may be used in conjunction with the wideband splitter 100, or as a stand-alone splitter device.

The foregoing description provides illustration and description but is not intended to be exhaustive or to limit the possible implementations to the precise form disclosed. Modifications and variations are possible in light of the above disclosure or may be acquired from practice of the implementations.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While the present disclosure has been disclosed with respect to a limited number of embodiments, those skilled in the art, having the benefit of this disclosure, will appreciate numerous modifications and variations there from. For example, some components, described as being separate pieces or parts, may be integrated into one component. Similarly, one component may be divided into one or more sub-components, pieces, or parts. It is intended that the appended claims cover such modifications and variations as fall within the true spirit and scope of the disclosure.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used.

What is claimed is:

1. A wideband splitter comprising:
an input port;
a first splitter;
a second splitter;
a first coupling unit;
a second coupling unit;
a third coupling unit;
a first output port; and
a second output port, wherein:
the input port is coupled to the first coupling unit and transmits an input signal received at the input port to the first coupling unit;
a low-pass node of the first coupling unit is coupled to the first splitter and transmits the input signal at a first frequency band to the first splitter;
a high-pass node of the first coupling unit is coupled to the second splitter and transmits the input signal at a second frequency band to the second splitter;
the first splitter is coupled to a low-pass node of the second coupling unit and to a low-pass node of the third coupling unit and transmits signals of the first frequency band to the second coupling unit and to the third coupling unit;
the second splitter is coupled to a high-pass node of the second coupling unit and to a high-pass node of the third coupling unit and transmits signals of the second frequency band to the second coupling unit and to the third coupling unit;
the second coupling unit is coupled to the first output port and combines the signals of the first and second frequency bands received from the first splitter and the second splitter; and
the third coupling unit is coupled to the second output port and combines the signals of the first and second frequency bands received from the first splitter and the second splitter.

2. The wideband splitter of claim 1, wherein the first output port is coupled to the second coupling unit via a common node of the second coupling unit, and the second output port is coupled to the third coupling unit via a common node of the third coupling unit.

3. The wideband splitter of claim 1, wherein the input signal has a frequency band ranging from approximately 5 megahertz (MHz) to 3000 MHz

4. The wideband splitter of claim 1, wherein the first frequency band ranges from approximately 5 MHz to 1000 MHz and the second frequency band ranges from approximately 1000 MHz to 3000 MHz and not limited with 3000 MHz.

5. The wideband splitter of claim 1, wherein the first splitter is a ferrite splitter and the second splitter is a Wilkinson splitter or a Wilkinson power divider.

6. The wideband splitter of claim 1, wherein:
a through split loss between the first output port and the input port is approximately 3.5 decibels (dB);
a through split loss between the second output port and the input port is approximately 3. dB; and
return losses at the input port, first output port, and second output port are greater than approximately 15 dB.

7. A wideband splitter comprising:
an input port configured to receive an input signal from a cable television (CATV) network;
a first coupling unit configured to receive the input signal and split the input signal into a first single at a first frequency band and a second signal at a second frequency band;
a first splitter configured to receive the first signal and split the first signal into a first plurality of output signals;
a second splitter configured to receive the second signal and split the second signal into a second plurality of output signals; and
a plurality of second coupling units configured to combine the first plurality of output signals and second plurality of output signals.

8. A wideband splitter comprising:
an input port;
a first splitter;
a second splitter;
a first coupling unit;
a second coupling unit;
a third coupling unit;
a first output port; and
a second output port, wherein:
the input port is coupled to the first coupling unit and transmits an input signal to the first coupling unit;
a low-pass node transmits the input signal at a first frequency band to the first splitter;
a high-pass node of the first coupling unit transmits the input signal at a second frequency band to the second splitter;
the first splitter transmits signals of the first frequency band to the second coupling unit and to the third coupling unit;
the second splitter transmits signals of the second frequency band to the second coupling unit and to the third coupling unit;
the second coupling unit is combines the signals of the first and second frequency bands received from the first splitter and the second splitter; and
the third coupling unit combines the signals of the first and second frequency bands received from the first splitter and the second splitter.

9. A wideband splitter comprising:
an input port configured to receive an input signal;
two or more output ports configured to output the input signal, wherein the wideband splitter is capable of splitting the input signal and transmitting the split input signal to the output ports across a frequency band ranging from approximately 5 MHz to 3000 MHz.
